(19) United States
(12) Patent Application Publication
(10) Pub. No.: US 2005/0157873 A1
(43) Pub. Date: Jul. 21, 2005

(54) Simplified method of RSA

(76) Inventor: Yoshihiro Tsukamura, Riverside, CA (US)

Correspondence Address: VINCENT J. MUCCIONE;C/O VISCOT INDUSTRIES, INC., P.O. BOX 351, EAST HANOVER, NJ, 07936, US

(21) Appl. No.: 10/762,054

(22) Filed: Jan. 21, 2004

(51) Int. Cl. H04K 1/00

(52) U.S. Cl. 380/30

(57) ABSTRACT

A simplified signing algorithm of the RSA formula is as follows:
Sign

$$\begin{matrix}Sx = Mx \{ Cx \} \\ = {Cx}^{Mx} ( mod no )\end{matrix}$$

Verify

$$Eo \{ Sx \}$$

$$\begin{matrix} = {Sx}^{eo} ( mod no ) \\ = {Cx}^{Mx * eo} ( mod no ) \\ = {Nx}^{do * Mx * eo} ( mod no ) \\ = {Nx}^{Mx} ( mod no )\end{matrix}$$

Since Nx^{do*eo} (mod no)=Nx where

| | |
|---|---|
| Nx | ID # of Entity X, License # issued to Entity X |
| Do | Private Key of System Authority O |
| Eo | Public Key of System Authority O |
| no | Modulus of the key pair Do, Eo |
| Cx | Secret Key of X where Cx = Nx^{do} (mod no) |
| Mx | Message sent by X |
| Sx | Message signed by X |

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

Field of Invention

This invention relates to the asymmetric key cryptographic method, RSA (U.S. Pat. No. 4,405,829), specifically to authentication and authorization using low-power devices such as contactless integrated circuit (IC) cards or remote key tokens.

2. Background of the Invention

This invention provides an authentication and authorization method for use with low-power devices such as contactless IC cards and remote key tokens.

Currently, the clock speed of a contactless IC card is slow because the card gets its power via radio frequency (RF) from the card's reader/writer.

For authentication and authorization, asymmetric cryptographic key systems are more secure than conventional symmetric key (Common Secret Key) systems.

In most cases, if an asymmetric cryptographic key system is deployed in a contactless IC card, calculation time is longer than the time required by the specific application.

### SUMMARY

The object of this invention, Simplified RSA (S-RSA), is to provide a simplified algorithm based on the RSA asymmetric key system, solving the aforementioned problem [005] by reducing the calculation time to less than 1/200 of the time required for standard RSA signing. The basic S-RSA formulae are shown in FIG. 10.

### BRIEF DESCRIPTION OF THE PROCESS FLOW AND FORMULAE—FIGURES

FIG. 1 is a table of the notations used in this application.

FIG. 2 is a block diagram of a communication system in accordance with this invention.

FIG. 3 is a flow of conventional password authentication.

FIG. 4 shows the formulae of symmetric key encryption.

FIG. 5 is a flow of conventional symmetric key authentication.

FIG. 6 shows the standard formulae of asymmetric key cryptographic algorithm of RSA.

FIG. 7 is a preparation flow of RSA system.

FIG. 8 is a flow of standard RSA key authentication.

FIG. 9 is a preparation flow of this invention, S-RSA.

FIG. 10 shows the signing formulae of this invention, S-RSA.

FIG. 11 is a authentication flow of this invention, S-RSA.

FIG. 12 is a payment flow of this invention, S-RSA.

FIG. 13 shows formulae and calculation times of Secure Socket Layer (SSL) communication.

FIG. 14 is a calculation time of this invention, S-RSA.

FIG. 15 is a table of powers of user key Ci for this invention, S-RSA.

### DETAILED DESCRIPTION

Notation

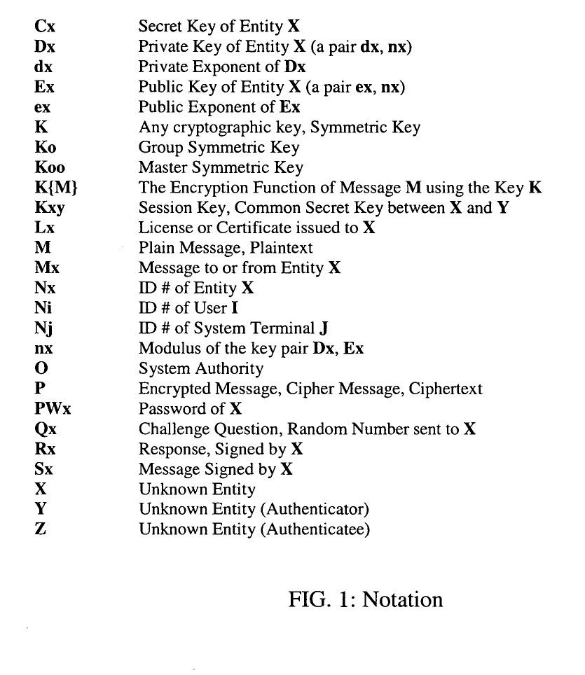

FIG. 1 outlines the notation used in this application. Bold capital letter represent entity names such as Y, Z or items such as an ID # N, or a key K. Lowercase bold suffixes signify a relation to the relative entity.

Block Diagram

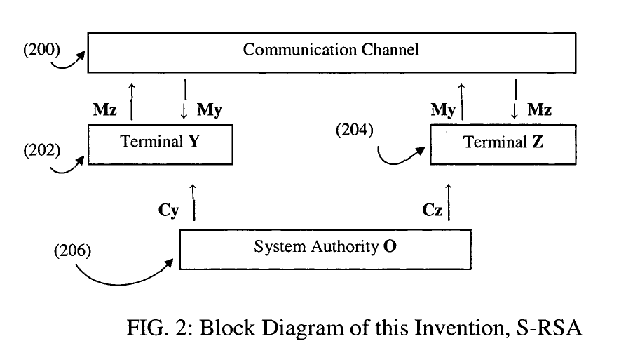

FIG. 2 provides an embodiment of this invention in the form of a block diagram. This system includes a communication channel (200) and at least two terminals Y (202) and Z (204) coupled to the channel (200) so that each terminal can send a message M to the other terminal and can receive M from the other terminal. System authority O (206) issues secret keys Cy and Cz to terminals Y and Z, respectively.

Conventional Password Authentication

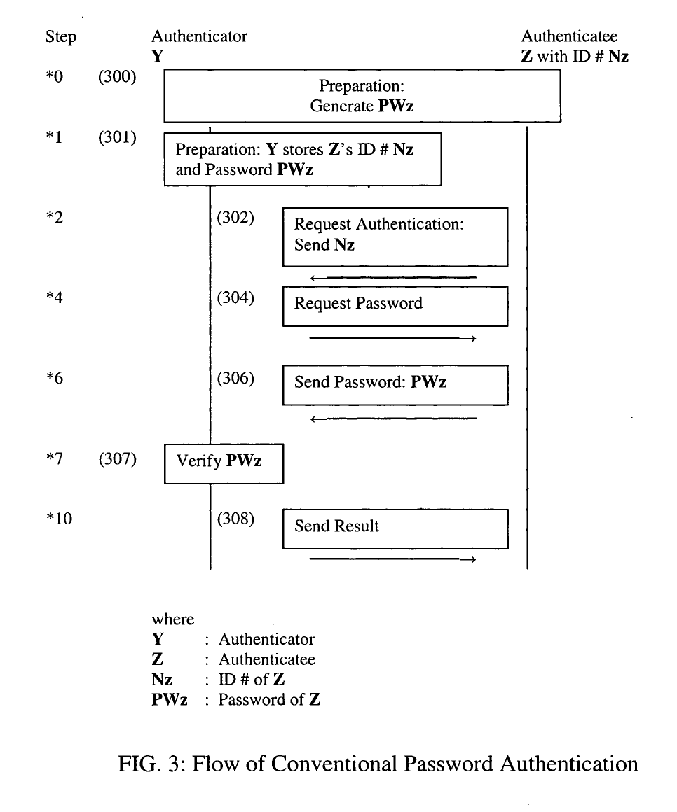

FIG. 3 is an example of the flow of conventional password authentication. In this case, Y authenticates Z via a digital network system or at a physical gate.

Flow (300)—Either Y or Z generates password PWz.

Flow (301)—In preparation, authenticator Y stores in its memory Z's ID # Nz and password PWz (or a hash value of it).

Flow (302)—Z sends its ID # Nz to Y, requesting authentication.

Flow (304)—Y requests Z's password PWz.

Flow (306)—Z sends its password to Y.

Flow (307)—In order to verify the password sent in Flow (306), Y compares it with the password stored in Flow (301).

Flow (308)—Y sends the result of the authentication process to Z: Accepted or Denied depending on Flow (307).

Problems with Conventional Password Authentication

As shown in [010]:
(a) Passwords can be used for authentication only-they cannot be used for authorization signing.
(b) Z can teach its password to someone else.
(c) Password PWz can be stolen or wire tapped at Flow (306).

Symmetric Key Encryption Formulae

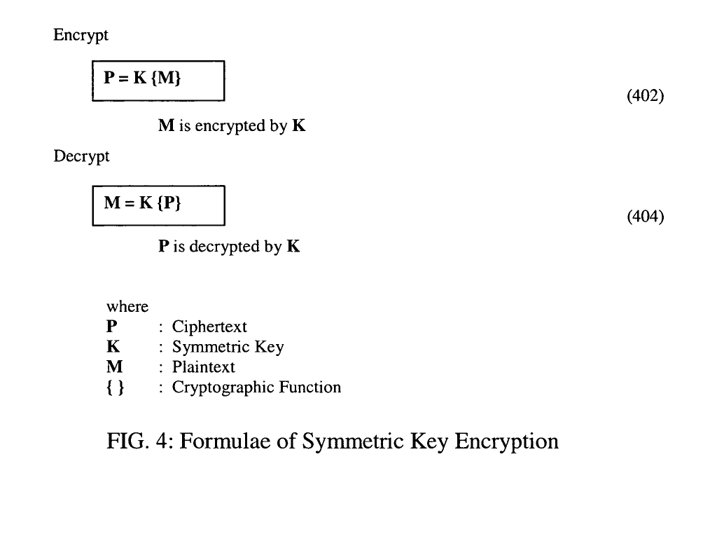

In FIG. 4, formula (402) is an equation of symmetric key (Common Secret Key) encryption in which plaintext M is encrypted by symmetric key K, producing ciphertext P.

Formula (404) is an equation of symmetric key decryption in which ciphertext P is decrypted by the same symmetric key K in order to reproduce the original message M.

Conventional Symmetric Key Authentication

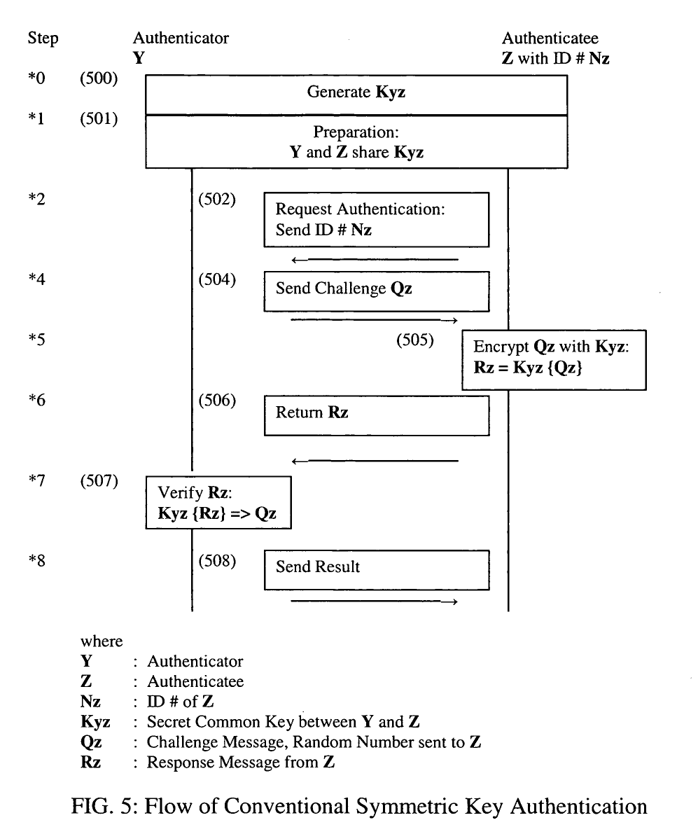

FIG. 5 illustrates an example of conventional authentication flow using a symmetric key algorithm.

In this case, Y uses an IC card reader or remote token reader to authenticate Z through a digital network or at a physical gate.

Flow (500)—Either Y or Z generates a secret key Kyz to be shared only between Y and Z.

Flow (501)—Both authenticator Y and authenticatee Z store Z's ID # Nz and the secret key Kyz.

Flow (502)—Z sends Nz to Y, requesting authentication.

Flow (504)—Y sends a random number Qz as a challenge message to Z.

Flow (505)—Z calculates the response message Rz by encrypting Qz with Kyz using formula (402): Rz=Kyz {Qz}.

Flow (506)—Z returns Rz to Y.

Flow (507)—Y verifies Rz, decrypting Rz with Kyz using formula (404): Kyz {Rz}=>Qz.

Flow (508)—Y sends the result of the authentication process to Z: Accepted or Denied depending on Flow (507).

Problems with Conventional Symmetric Key Authentication As shown in [013]:
(a) A symmetric key (Common Secret Key) algorithm can be used for authentication and secret communication only-it cannot be used for authorization.
(b) A symmetric key algorithm can be used only between Y and Z.
(c) In some systems, multiple terminals (Yj) or multiple users (Zi) share the same symmetric group key Ko or the same master key Koo to derive each common key. This results in vulnerability because if a terminal or authentication device is analyzed, then Ko or Koo can be discovered. This logical damage is detrimental to the entire system.

Standard RSA Key Authentication

Due to the limitations outlined in [014], an asymmetric key system is more efficient and secure than a symmetric key system.

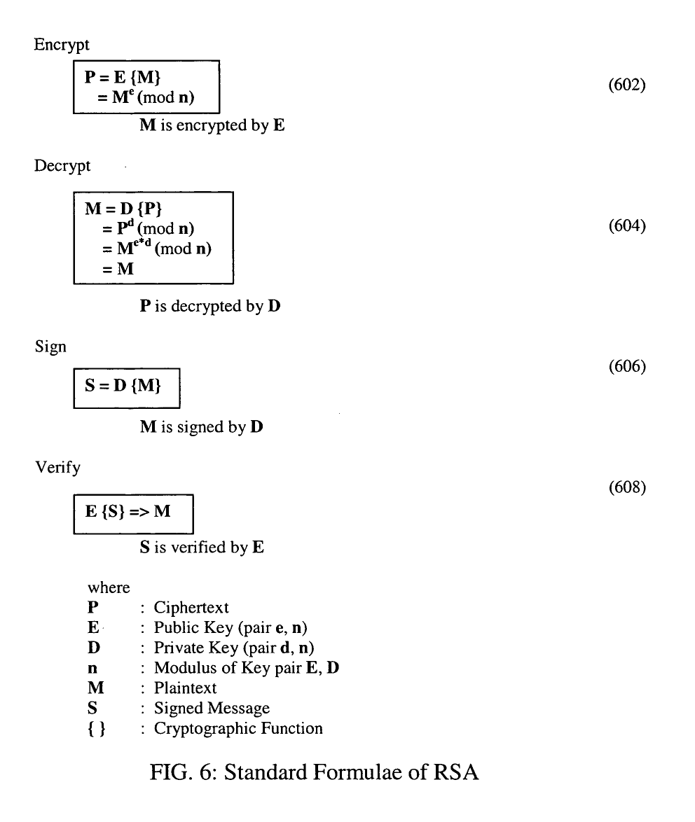

FIG. 6 illustrates the standard formulae of the asymmetric key system of the RSA cryptographic method.

In this system, a pair of keys is used: a public key E, and a private key D.

Public key E is made available to the public.

Private key D is kept secret by its owners.

E consists of a pair e, n and D consists of a pair d, n where

n is the modulus of E and D.

In this description, the key size n is assumed to be a standard 1024 bits.

Preparation Flow of Standard RSA Key Authentication

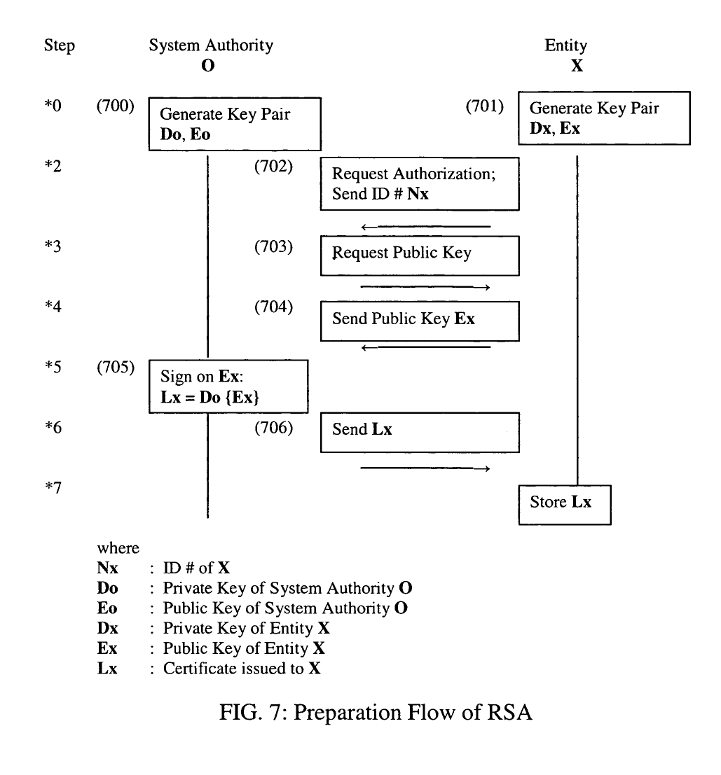

FIG. 7 shows a preparation flow of the RSA cryptographic method.

In the RSA system, key user X must obtain a key certificate Lx from the system authority or certificate authority O.

The main function of the key certificate is authorization of X's public key Ex, signing on Ex by the authority's private key Do in formula (705).

Flow of Standard RSA Key Authentication

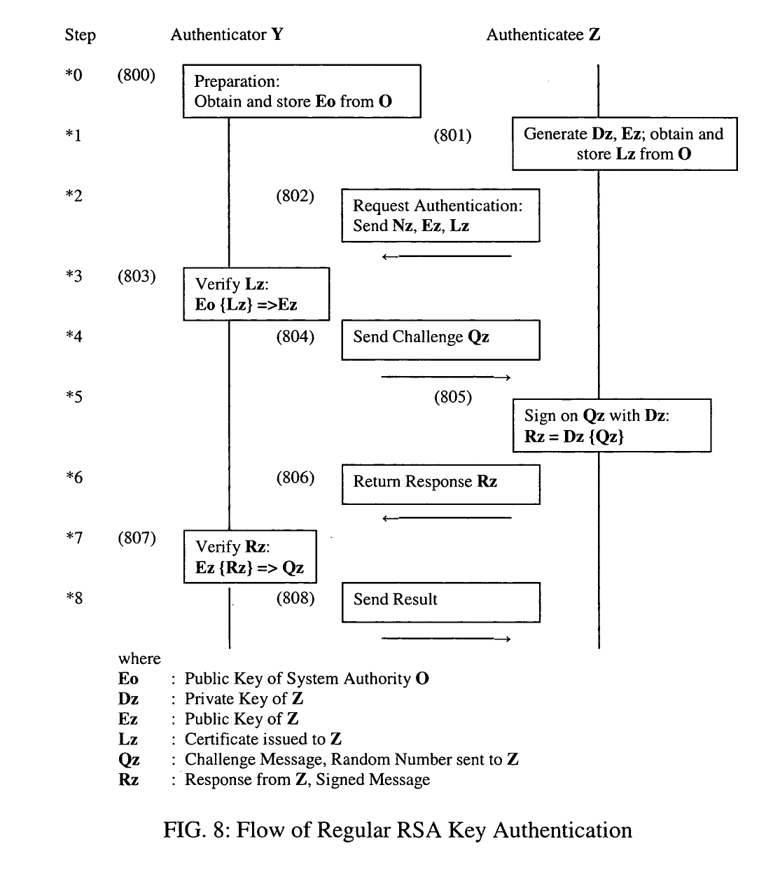

FIG. 8 shows a flow of standard RSA key authentication.

In this flow, Y uses an IC card reader or token reader to authenticate Z through a digital network or at a physical gate.

Flow (800)—Y prepares system authority O's public key Eo, obtained from O.

Flow (801)—In preparation, Z generates its key pair Dz, Ez, and receives key certificate Lz from O via the process illustrated in FIG. 7.

Flow (802)—Z requests authentication to Y, sending its ID # Nz, its public key Ez, and Lz. (Basically, Nz and Ez are included in one certificate.)

Flow (803)—Y verifies the genuineness of Nz and Ez using formula (608): Eo {Lz}=>Ez.

Flow (804)—Y sends a random number Qz as a challenge message to Z.

Flow (805)—Z calculates the response message Rz, signing on Qz with Dz using formula (606): Rz=Dz {Qz}.

Flow (806)—Z returns Rz to Y.

Flow (807)—Y verifies Rz using formula (608): Ez {Rz}=>Qz.

Flow (808)—Y sends the result of the authentication process to Z: Accepted or Denied depending on Flow (807).

Problems with Standard RSA Key Authentication
(a) The memory size of a low-cost contactless IC card or remote key token (usually 4-8 KB) is too small to store a standard 1024 bit (128 bytes) key pair Dz, Ez, and a standard X.509 certificate which consists of 3-4 KB (especially since most users will need to store other data on the device as well).
(b) A more critical issue manifests in Flow (805):
   Using a 500 KHz CPU clock, it takes more than 5 seconds to sign on the challenge message Qz using a standard 1024 bit key.
   It is difficult to increase the CPU clock speed in order to speed up calculation time because power is supplied to the card or token via weak RF from a certain distance.

This invention: S-RSA Authentication

In order to solve the above problem [018], this invention provides a simplified cryptographic method based on RSA.

S-RSA Authentication takes less than 1/200 of the calculation time found Flow (805) of the standard 1024 bit RSA signing operation.

Preparation Flow of S-RSA

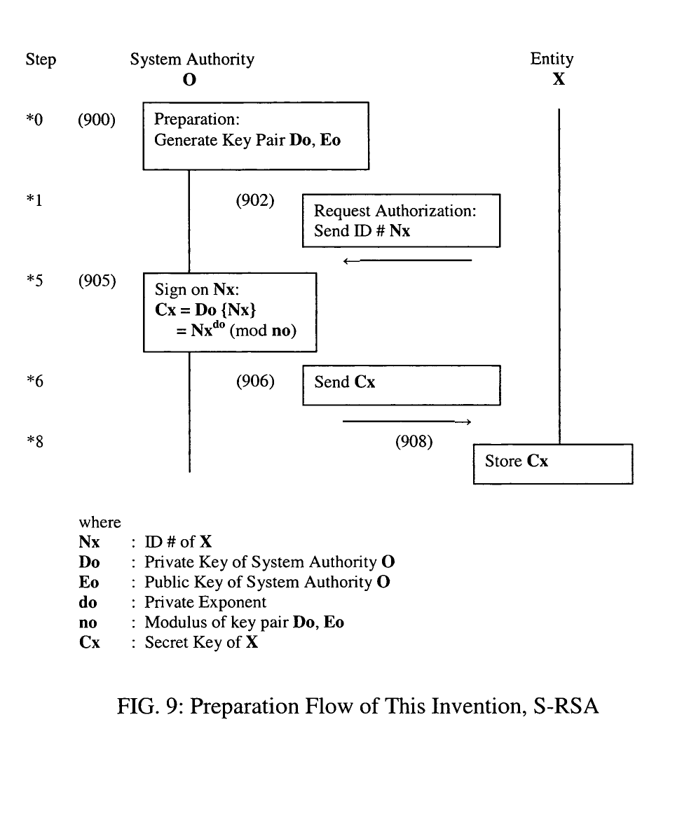

FIG. 9 shows a preparation flow of S-RSA, which is similar to the flow of the standard RSA algorithm, only simpler.

Flow (900)—System authority O prepares its key pair Do, Eo in the same manner as in Flow (700) of FIG. 7.

Flow (902)—X sends only its ID # or License # Nx, instead of both Nx as in Flow (702) and Ex as in Flow (704).

Flow (905)—System authority O authorizes Nx, signing on Nx using O's private key Do.

Cx is a very simple certificate issued to X. Cx is only 1024 bits (128 bytes), much smaller in size than the 3-4 KB X 0.509 certificate required for RSA operations.

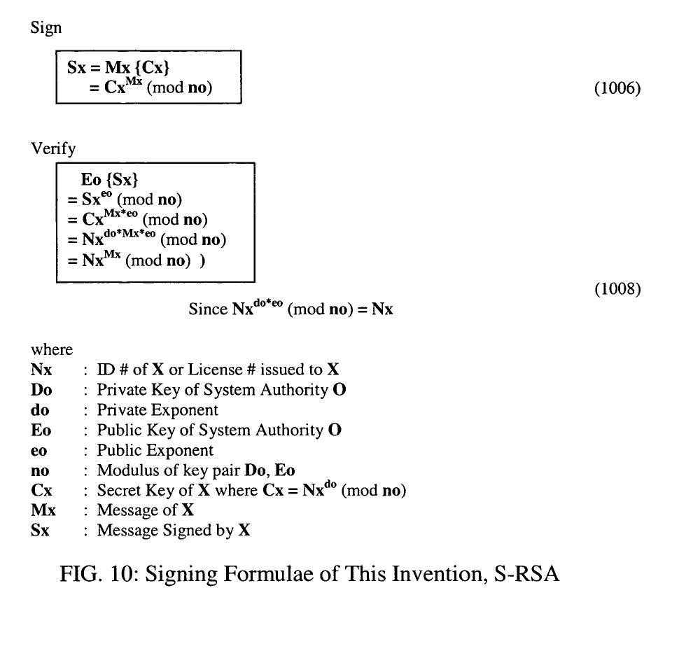

FIG. 10 illustrates the formulae for signing and verifying with this invention, S-RSA. Formula (1006) is the essence of this invention.

For signing operations:

Key Cx is encrypted by message Mx, instead of encrypting message M using key D as in Flow (606).

That is, the operator (Key) and operand (Message) are inverted.

Formula (1008) shows how to verify the signed message Sx by encrypting Sx with Eo, the same as in Flow (608).

The Eo {Sx} operation becomes Nx^{Mx} (a value known by the verifier).

Flow of S-RSA Key Authentication

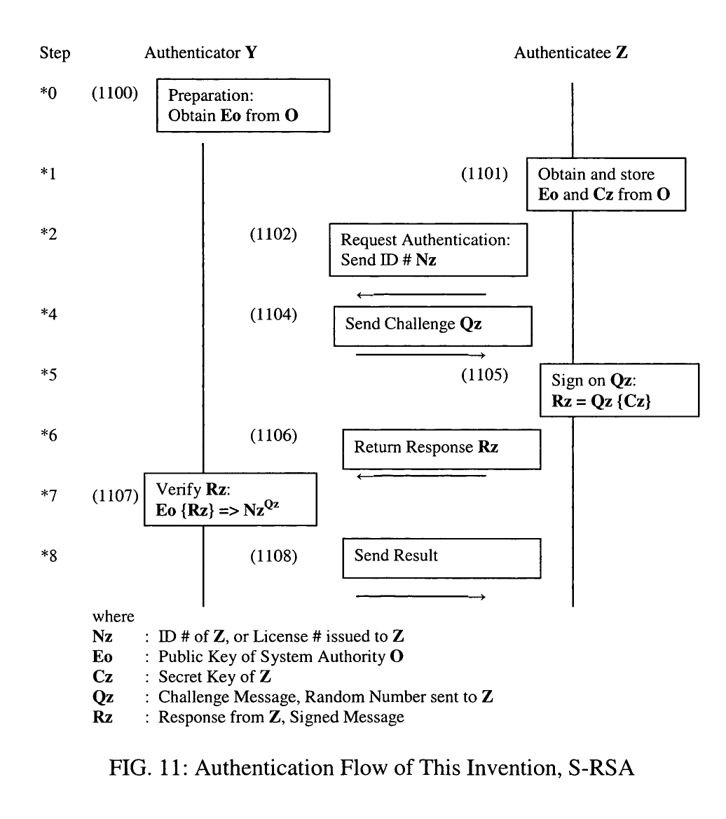

FIG. 11 illustrates the flow of S-RSA key authentication.

In this flow, Y uses an IC card reader or token reader to authenticate Z through a digital network or at a physical gate.

Flow (1100)—Y prepares system authority O's public key Eo, obtained from O as in Flow (800).

Flow (1101)—In preparation, Z receives its secret key Cz from O (as in Flows (900) through (908) in FIG. 9).

Flow (1102)—Z sends its ID # Nz to Y, requesting authentication.

Flow (1104)—As a challenge message to Z, Y sends a random number Qz which is smaller than eo.

Qz is normally 16 bits, because a standard public exponent eo is 2¹⁶+1(17 bits).

Flow (1105)—Z calculates the response message Rz, signing on Qz with Cz using formula (1006): Rz=Qz {Cz}.

Flow (1106)—Z returns Rz to Y.

Flow (1107)—Y verifies Rz using formula (1008): Eo {Rz}=>NzQZ (a value known by Y).

Flow (1108)—Y sends the result of the authentication process to Z: Accepted or Denied depending on Flow (1107).

Using this process, Y can authenticate Z using simple calculation without knowing Z's secret key Cz.

If Z needs to be authenticated more than 1/10 of 2¹⁶ (or 65536/10) times, it is recommended that Z obtain a revised secret key Cz from O using a new ID # Nz′=Nz+Expiration Date, where the expiration date is established by system authority O.

Payment Flow of S-RSA

S-RSA can be used for small payments, similar to debit card transactions.

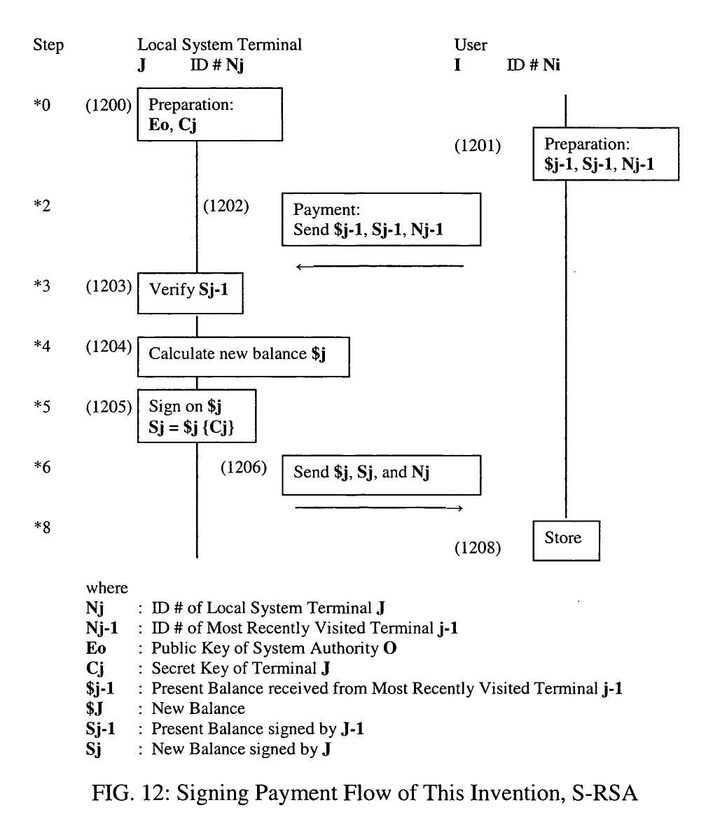

FIG. 12 provides an example flow of an S-RSA debit card payment.

Flow (1200)—Local system terminal J, whose terminal ID # is Nj, prepares Eo and Cj (obtained from the system authority O) as in Flows (900) through (908).

Flow (1201)—User I, with ID # Ni, has a present balance of $j−1, a signed balance of Sj−1 and a terminal ID # Nj−1. Nj−1, $j−1 and Sj−1 are provided by terminal J−1, at which user I most recently made a payment.

Prior to the transaction, the user's IC card or token is authenticated as in Flows (100) through (1108).

Flow (1202)—User I sends $j−1, Sj−1 and Nj−1 to J.

Flow (1203)—J verifies Sj−1 using formula (1008).

Flows (1204) and (1205)—J calculates I's new balance and signs on it with J's secret key Cj using formula (1006).

Flow (1206)—J returns the new values $j, Sj and Nj to user I. If necessary, user I's IC card or token can easily verify these values.

Generally, a balance document $j consists of an actual present balance, date, Ni and Nj, and therefore consists of over 16 bits.

This invention, S-RSA, saves storage space by signing the authorized balance Sj on the combination number of an 8 bit hash value of the $j document plus an 8 bit value indicating the date of the event within the expiration date mentioned in [023], using only 16 bits.

To increase flexibility, the system can utilize a slightly longer eo (e.g. 20 bits) which would provide greater security and allow for a later expiration date, but would also require more calculation time.

Calculation Time of S-RSA

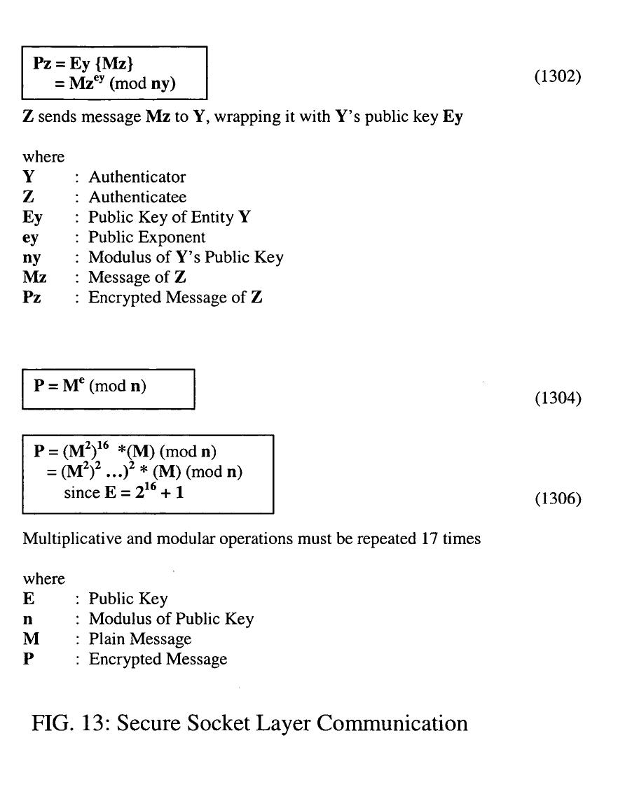

FIG. 13 expresses the calculation time for a message sent through Secure Socket Layer (SSL).

Since user-side calculation is minimal, SSL is commonly used when a user sends its password to a registered website for authentication or its credit card number to an on-line shop.

Formula (1302) is the SSL message wrapping formula. User Z (the authenticatee) sends its password or session key Mz to the message receiver Y (the authenticator).

Formulas (1304) through (1306) comprise the general formulae of SSL message wrapping.

The multiplicative and modular operations must be repeatedly performed 17 times.

The calculation in formula (1306) only requires about 1/100 of the time required by the standard RSA signing operation since e is usually 2¹⁶+1 (even though n is 1024 bits).

S-RSA Calculation

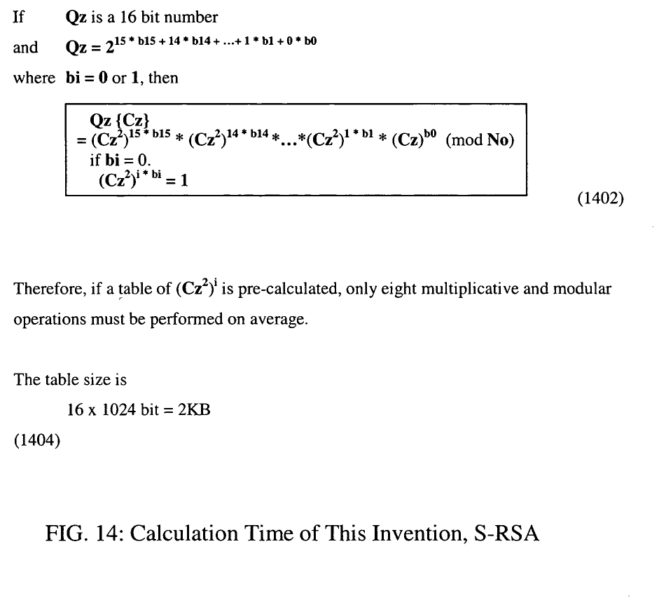

In FIG. 14, formula (1402) shows the calculation formula of S-RSA.

If the challenge message Q is a 16-bit number, the multiplicative and modular operations must be performed only 8 times on average, (if a table of powers of Cz is pre-calculated) cutting the required SSL calculations in half.

Table of Powers of Cz

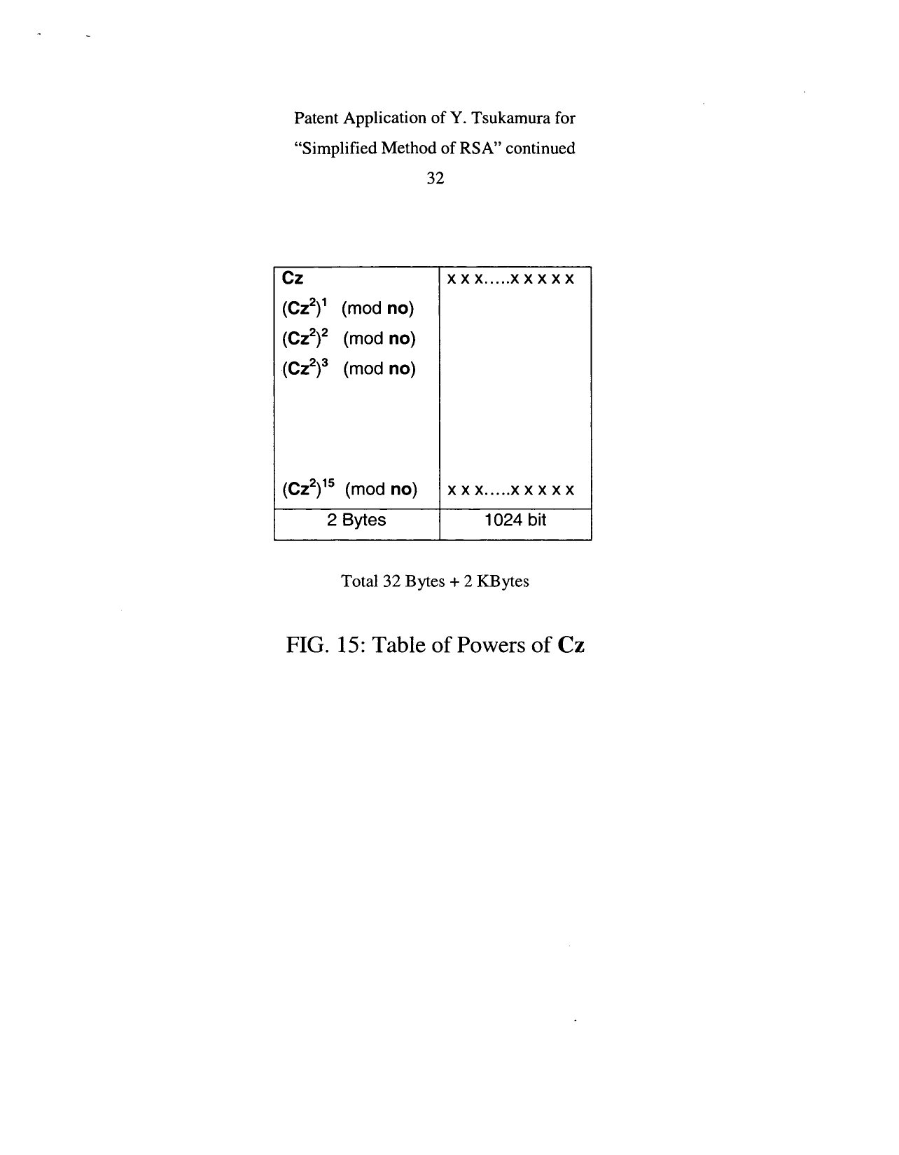

The example table of powers of Cz shown in FIG. 15 requires just over 2 KB.

Applications

As demonstrated in the above description, there are numerous applications of this invention, Simplified-RSA.

Device Applications

Because of the simplicity of authentication, in addition to the contactless IC cards and remote key tokens previously described, S-RSA can be installed onto any portable digital device such as a key holder, contact IC card, cellular phone, camera, palm computer, etc. Furthermore, a device may include password check or biometric check functionality in order to develop an ownership relation with its owner.

System Applications

The S-RSA method can be used with many various systems using one of the devices described in [030]. In addition to physical gate authentication and payment systems described above, this method is useful for computer login applications, server login applications, and any license system as described below.

License System Application

The S-RSA method is useful for the distribution of digital tickets within any simple licensing system. Examples include AV rendering, theater ticket assignment and voting ticket allocation.

The essence of a license system is to confirm the presence of a licensed item or person.

If the licensed entity is a person, whether a device is simply held by the owner or activated by a password or biometric method, the device's presence can be authenticated on behalf of the owner. This invention provides a simple device authentication method.

1. A method of digital signing on a digital message, comprising:
(a) providing a communication channel,
(b) providing a system authority means O which governs a private key Do and a public key Eo,
where
Do: private key of said system authority means O consisting of do and no in accordance with the RSA cryptographic method described in U.S. Pat. No. 4,405,829
do: private exponent of said Do
Eo: public key of said system authority means O consisting of eo and no in accordance with the RSA cryptographic method
eo: public exponent of said Eo
no: modulus of the key pair Do, Eo,
(c) providing at least one message sender means Z with an assigned ID # Nz,
(d) providing at least one message receiver means Y,
(e) said system authority means O providing Cz and said Eo to said Z and said Eo to said Y,
where
Cz: a secret key of said Z such that
$$\begin{matrix}Cz = Do \{ Nz \} \\ = {Nz}^{do} ( mod no ) ,\end{matrix}$$
{ }: a cryptographic operation in accordance with the RSA cryptographic method,
(f) said Z providing a digital message Mz and transforming said Mz into a signed message Sz and then sending said Nz, said Mz and said Sz to said Y via said communication channel, where
$$\begin{matrix}Sz = Mz \{ Cz \} \\ = {Cz}^{Mz} ( mod no ) ,\end{matrix}$$
(g) said Y receiving said Nz, said Mz and said Sz, and verifying said Sz by examining
Eo {Sz} and Nz^{Mz}(mod no),
where
Eo {Sz}=Sz^{eo}(mod no),
whereby said message sender means Z can sign on said message Mz using less calculation than is necessary with the standard RSA cryptographic method, and said message receiver means Y can verify the genuineness of said signed message Sz without knowing said Z's secret key Cz.

2. A method according to claim 1 wherein said message sender means Z's assigned ID # Nz includes information about its own expiration date, whereby said message receiver means Y can validate said assigned ID # Nz.

3. A method according to claim 1 wherein said message sender means Z prepares pre-calculated tables of powers of said secret key Cz.

4. A method according to claim 1 wherein said digital message Mz includes a hash value of information about an account balance.

5. A method according to claim 1 wherein said digital message Mz includes information about the date of its own generation, whereby said digital message Mz is more difficult to duplicate.

6. A method of digital authentication, comprising:
(a) providing a communication channel,
(b) providing a system authority means O which governs a private key Do and a public key Eo,
where
Do: private key of said system authority means O consisting of do and no in accordance with the RSA cryptographic method described in U.S. Pat. No. 4,405,829
do: private exponent of said Do
Eo: public key of said system authority means O consisting of eo and no in accordance with the RSA cryptographic method
eo: public exponent of said Eo
no: modulus of the key pair Do, Eo,
(c) providing at least one authenticator means Y,
(d) providing at least one authenticatee means Z with an assigned ID # Nz,
(e) said system authority means O providing Cz and said Eo to said Z and said Eo to said Y,
where
Cz: a secret key of said Z such that
$$\begin{matrix}Cz = Do \{ Nz \} \\ = {Nz}^{do} ( mod no ) ,\end{matrix}$$
{ }: a cryptographic operation in accordance with the RSA cryptographic method,
(f) said Z sending said Nz to said Y and requesting to be authenticated,
(g) said Y generating a challenge message Mz and sending it to said Z,
(h) said Z receiving said Mz, transforming it into a signed message Sz and sending said Sz to said authenticator means Y via said communication channel, where
$$\begin{matrix}Sz = Mz \{ Cz \} \\ = {Cz}^{Mz} ( mod no ) .\end{matrix}$$
(i) said Y receiving and verifying said Sz by examining Eo {Sz} and Nz^{Mz} (mod no),
where
Eo {Sz}=Sz^{eo} (mod no),
whereby said authenticatee means Z can be authenticated using less calculation than is necessary with the standard RSA cryptographic method, and said authenticator means Y can verify the genuineness of said signed message Sz without knowing said Z's secret key Cz.

7. A method according to claim 6 wherein said message sender means Z's assigned ID # Nz includes information about its own expiration date, whereby said message receiver means Y can validate said Nz.

8. A method according to claim 6 wherein said message sender means Z prepares pre-calculated tables of powers of said secret key Cz.

9. A method according to claim 6 wherein said challenge message Mz includes information about the date of its own generation, whereby said Mz is more difficult to duplicate.

10. An authentication device that is used in a digital communication system, where said digital communication system comprises:
(a) a communications channel,
(b) a system authority means O for providing Cx and Eo to any entity X in the system,
where
Cx: a secret key of said X such that
$$\begin{matrix}Cx = Do \{ Nx \} \\ = {Nx}^{do} ( mod no )\end{matrix}$$
{ }: a cryptographic operation in accordance with the RSA cryptographic method described U.S. Pat. No. 4,405,829
Nx: ID # assigned to said X
Do: private key of said system authority means O consisting of do and no in accordance with the RSA cryptographic method
do: private exponent of said Do
Eo: public key of said system authority means O consisting of eo and no in accordance with the RSA cryptographic method
eo: public exponent of said Eo
no: modulus of the key pair Do, Eo,
(c) at least one message sender means Z coupled to said communication channel,
(d) at least one message receiver means Y coupled to said communication channel, and said authentication devices is adapted for receiving said Cx and said Eo from said system authority means O and for transforming a digital message M to a signed message S and for transmitting said S via said communication channel, where
$$\begin{matrix}S = M \{ Cx \} \\ = {Cx}^{M} ( mod no ) .\end{matrix}$$

11. A device according to claim 10 wherein a table of the powers of said Z's secret key Cz is prepared.
